(19) United States
(12) Patent Application Publication
(10) Pub. No.: US 2023/0186664 A1
(43) Pub. Date: Jun. 15, 2023

(54) METHOD FOR TEXT RECOGNITION

(71) Applicant: BEIJING BAIDU NETCOM SCIENCE TECHNOLOGY CO., LTD., BEIJING (CN)

(72) Inventors: Shanshan LIU, Beijing (CN); Meina QIAO, Beijing (CN); Liang WU, Beijing (CN); Pengyuan LV, Beijing (CN); Sen FAN, Beijing (CN); Chengquan ZHANG, Beijing (CN); Kun YAO, Beijing (CN)

(21) Appl. No.: 18/169,032

(22) Filed: Feb. 14, 2023

(30) Foreign Application Priority Data
Apr. 6, 2022 (CN) 202210359921.1

(51) Int. Cl. G06V 30/19; G06V 30/30

(52) U.S. Cl. CPC G06V 30/19173; G06V 30/19147; G06V 30/30

(57) ABSTRACT

A method for text recognition is disclosed. The method includes obtaining a whole-image scenario for an image to be processed and a text image in the image to be processed. The method further includes determining a first text recognition model corresponding to the whole-image scenario. The method further includes performing text recognition on the text image according to the first text recognition model to obtain text information.

### CROSS-REFERENCE TO RELATED APPLICATIONS

This application claims priority to Chinese Patent Application No. 202210359921.1, filed on Apr. 6, 2022, the contents of which are hereby incorporated by reference in their entirety for all purposes.

### TECHNICAL FIELD

The present disclosure relates to the technical field of artificial intelligence, and particularly relates to the technical fields of deep learning, image processing and computer vision, which can be applied to scenarios such as optical character recognition (OCR). Particularly, the present disclosure provides a method and apparatus for text recognition, an electronic device, a computer readable storage medium and a computer program product.

### BACKGROUND

Artificial intelligence is a subject to study to make computers simulate certain thinking processes and intelligent behaviors (such as learning, reasoning, thinking, planning, etc.) of people, and has both a hardware-level technology and a software-level technology. Artificial intelligence hardware technologies generally include technologies such as sensors, dedicated artificial intelligence chips, cloud computing, distributed storage, and big data processing. Artificial intelligence software technologies mainly include a computer vision technology, a speech recognition technology, a natural language processing technology, machine learning/deep learning, a big data processing technology, a knowledge mapping technology and other major directions.

In recent years, the research and development of a text recognition technology has continued to deepen, making it widely used in many application fields. The automated and efficient text recognition can effectively alleviate labor costs and improve the level of intelligent operations. Therefore, how to provide more effective text recognition is still a hot research topic. With the continuous progress of science, technology and society, the application of text recognition has become more extensive, which has led to more diverse scenarios related to text recognition, and a distribution of words has also become more complex, which has brought more technical challenges to text recognition.

Methods described in this section are not necessarily those previously envisaged or adopted. Unless otherwise specified, it should not be assumed that any method described in this section is considered the prior art only because it is included in this section. Similarly, unless otherwise specified, the issues raised in this section should not be considered to have been universally acknowledged in any prior art.

### SUMMARY

The present disclosure provides a method and apparatus for text recognition, an electronic device, a computer readable storage medium and a computer program product.

According to an aspect of the present disclosure, a method for text recognition is provided. The method includes obtaining a whole-image scenario for an image to be processed and a text image in the image to be processed; determining a first text recognition model corresponding to the whole-image scenario; and performing text recognition on the text image based on the first text recognition model to obtain text information.

According to another aspect of the present disclosure, an electronic device is provided, including at least one processor; and a memory in communication connection with the at least one processor, wherein the memory stores instructions executable by the at least one processor, and the instructions, when executed by the at least one processor, enable the at least one processor to execute the method as described above.

According to another aspect of the present disclosure, a non-transitory computer readable storage medium storing computer instructions is provided, where the computer instructions, when executed by a computer, are configured to cause the computer to execute the method as described above.

It should be understood that the content described in this part is not intended to identify key or important features of the embodiments of the present disclosure, nor is it used to limit the scope of the present disclosure. Other features of the present disclosure will be easily understood by the following description.

### BRIEF DESCRIPTION OF THE DRAWINGS

The accompanying drawings in some embodiments illustrate embodiments and form part of the description, which, together with the textual description of the description, is configured to explain example implementations of the embodiments. The illustrated embodiments are for illustrative purposes only and do not limit the scope of the claims. In all the drawings, the same reference numerals refer to similar but not necessarily identical elements.

FIG. 1 shows a schematic diagram of an example system in which various methods described herein may be implemented according to an embodiment of the present disclosure.

FIG. 2 shows a flow diagram of a text recognition method according to an embodiment of the present disclosure.

FIG. 3 shows a flow diagram of a text recognition method according to another embodiment of the present disclosure.

FIG. 4 shows a schematic diagram of an automated recognition service pipeline for illustrating a text recognition method according to an embodiment of the present disclosure.

FIG. 5 shows a structural block diagram of a text recognition apparatus according to an embodiment of the present disclosure.

FIG. 6 shows a structural block diagram of a text recognition apparatus according to another embodiment of the present disclosure.

FIG. 7 shows a structural block diagram of an example electronic device capable of being used to implement an embodiment of the present disclosure.

### DETAILED DESCRIPTION

The example embodiments of the present disclosure are described below in combination with the accompanying drawings, including various details of the embodiments of the present disclosure to facilitate understanding, which should be considered only example. Therefore, those ordinarily skilled in the art should recognize that various changes and modifications may be made to the embodiments described herein without departing from the scope of the present disclosure. Similarly, for clarity and conciseness, the description of well-known functions and structures is omitted from the following description.

In the present disclosure, unless otherwise specified, the terms “first”, “second” and the like are used to describe various elements and are not intended to limit the positional relationship, temporal relationship or importance relationship of these elements. These terms are only configured to distinguish one element from another element. In some examples, a first element and a second element may point to the same instance of the element, and in some cases, based on the context description, they can also refer to different instances.

The terms used in the description of the various examples in the present disclosure are only for the purpose of describing specific examples and are not intended to be limiting. Unless the context clearly indicates otherwise, if the quantity of elements is not specifically limited, the element may be one or more. In addition, the term “and/or” as used in the present disclosure covers any and all possible combinations of the listed items.

In the related art, facing the problems due to more diverse text recognition scenarios and a complicated distribution of words, there is no effective solution. This may be attributed to the fact that traditional text recognition generally uses a single general-used word detection model and text recognition model for processing, which makes it difficult to accurately determine the scenario when input images involve different scenarios, thereby affecting the accuracy of text recognition. At the same time, it cannot deal well with the problem of uneven distribution of words or more layouts.

In addition, since traditional text recognition methods process a plurality of text lines in a serial manner, this also leads to the problem of low recognition speed or rate bottlenecks.

Aiming at the above technical problems, the present disclosure provides a text recognition method. The embodiments of the present disclosure will be described in detail below in combination with the accompanying drawings.

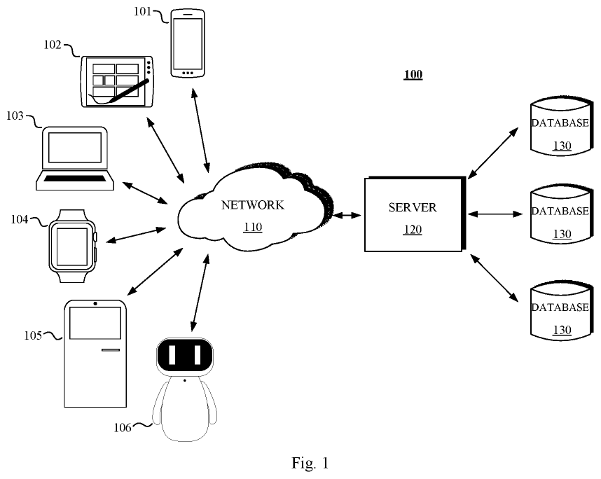

Before describing the methods of the embodiments of the present disclosure in detail, an example system in which the methods of the embodiments of the present disclosure may be implemented is first described in combination with FIG. 1.

The embodiments of the present disclosure will be described in detail below in combination with the accompanying drawings.

FIG. 1 shows a schematic diagram of an example system 100 in which various methods and apparatuses described herein may be implemented according to an embodiment of the present disclosure. Referring to FIG. 1, the system 100 includes one or more client devices 101, 102, 103, 104, 105 and 106, a server 120 and one or more communication networks 110 coupling the one or more client devices to the server 120. The client devices 101, 102, 103, 104, 105 and 106 may be configured to execute one or more applications.

In the embodiment of the present disclosure, the server 120 may run to make one or more services or software applications of the text recognition method according to the embodiment of the present disclosure capable of being executed.

In certain embodiments, the server 120 may further provide other services or software applications that may include non-virtual environments and virtual environments. In certain embodiments, these services may be provided as web-based services or cloud services, such as being provided to users of the client devices 101, 102, 103, 104, 105 and/or 106 under a software as a service (SaaS) model.

In a configuration shown in FIG. 1, the server 120 may include one or more components implementing functions executed by the server 120. These components may include a software component, a hardware component or their combinations that may be executed by one or more processors. The users operating the client devices 101, 102, 103, 104, 105 and/or 106 may sequentially utilize one or more client applications to interact with the server 120 so as to utilize services provided by these components. It should be understood that various different system configurations are possible, which may be different from the system 100. Therefore, FIG. 1 is an example of a system for implementing the various methods described herein and is not intended to be limiting.

The users may use the client devices 101, 102, 103, 104, 105 and/or 106 to input an image to be processed, where the image to be processed includes a text to be recognized. The client devices may provide interfaces enabling the users of the client devices to be capable of interacting with the client devices. The client devices may further output information to the users via the interfaces. Although FIG. 1 only depicts six client devices, those skilled in the art can understand that the present disclosure may support any quantity of client devices.

The client devices 101, 102, 103, 104, 105 and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various message transceiving devices, a sensor or other sensing devices, etc. These computer devices may run various types and versions of software applications and operating systems, such as MICROSOFT® Windows®, APPLE iOS, UNIX®-like operating systems, and Linux or Linux-like operating systems (such as GOOGLE® Chrome OS®); or include various mobile operating systems, such as MICROSOFT® Windows Mobile OS®, iOS®, Windows Phone® and Android®. The portable handheld device may include a cell phone, a smart phone, a tablet computer, a personal digital assistant (PDA) and the like. The wearable device may include a head-mounted display (such as smart glasses) and other devices. The gaming system may include various handheld gaming devices, gaming devices supporting the Internet and the like. The client devices may execute various different applications, such as various Internet-related applications, communication applications (such as e-mail applications), and short message service (SMS) applications, and may use various communication protocols.

The network 110 may be any type of network well known to those skilled in the art, which may use any one of various available protocols (including but not limited to Transmission Control Protocol/Internet Protocol (TCP/IP), Systems Network Architecture (SNA), Internetwork Packet Exchange (IPX), etc.) to support data communication. Only as examples, one or more networks 110 may be a local area network (LAN), an Ethernet-based network, a token ring, a wide area network (WAN), the Internet, a virtual network, a virtual private network (VPN), an intranet, an external network, a public switched telephone network (PSTN), an infrared network, a wireless network (e.g., Bluetooth®, WiFi (wireless fidelity)), and/or any combination of these and/or other networks.

The server 120 may include one or more general-purpose computers, dedicated server computers (e.g., PC (personal computer) servers, UNIX® servers, and midrange servers), blade servers, mainframe computers, server clusters, or any other suitable arrangement and/or combination. The server 120 may include one or more virtual machines running virtual operating systems, or other computing frameworks involving virtualization (e.g., one or more flexible pools of logical storage devices that may be virtualized to maintain virtual storage devices of the server). In various embodiments, the server 120 may run one or more service or software applications providing the functions described below.

A computing unit in the server 120 may run one or more operating systems including any above operating system and any commercially available server operating system. The server 120 may further run any one of various additional server applications and/or intermediate layer applications, including an Hypertext Transfer Protocol (HTTP) server, a File Transfer Protocol (FTP) server, a Common Gateway Interface (CGI) server, a JAVA server, a database server and the like.

In some implementations, the server 120 may include one or more applications to analyze and combine data feed and/or event updating received from the users of the client devices 101, 102, 103, 104, 105 and/or 106. The server 120 may further include one or more applications to display data feed and/or real-time events via one or more display devices of the client devices 101, 102, 103, 104, 105 and/or 106.

In some implementations, the server 120 may be a server of a distributed system, or a server combined with a block chain. The server 120 may further be a cloud server, or a smart cloud computing server or smart cloud host with the artificial intelligence technology. The cloud server is a host product in a cloud computing service system to solve the defects of large management difficulty and weak business expansibility existing in traditional physical host and virtual private server (VPS) services.

The system 100 may further include one or more databases 130. In certain embodiments, these databases may be configured to store data and other information. For example, one or more of the databases 130 may be configured to store, for example, information of video files and video files. The databases 130 may reside at various positions. For example, a database used by the server 120 may be local to the server 120 or may be away from the server 120 and may communicate with the server 120 via and based on a network or specific connection. The databases 130 may be of different types. In certain embodiments, the database used by the server 120, for example, may be a relational database. One or more of these databases may respond to a command to store, update and retrieval data to and from the databases.

In certain embodiments, one or more of the databases 130 may further be used by applications to store application data. The databases used by the applications may be different types of databases, such as a key value storage base, an object storage base or a conventional storage base supported by a file system.

The system 100 of FIG. 1 may be configured and operated in various modes to be capable of applying various methods and apparatuses described according to the present disclosure.

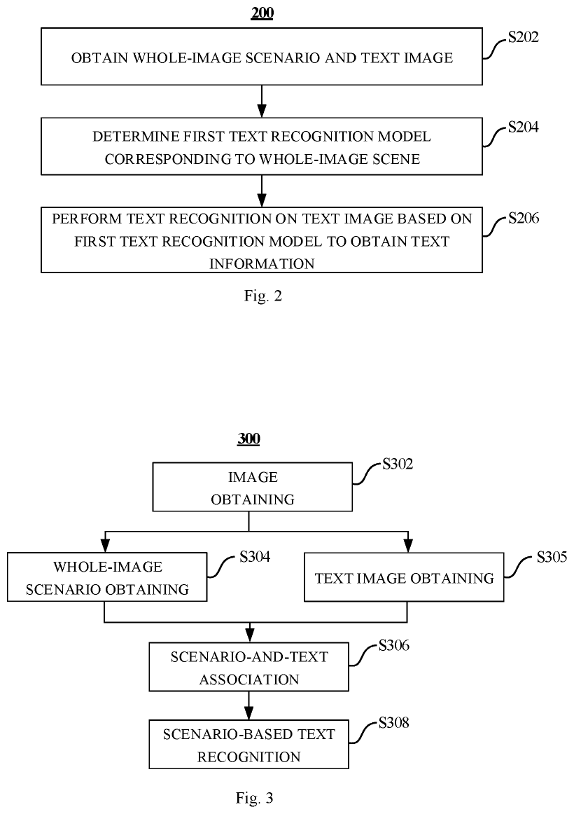

FIG. 2 shows a flow diagram of a text recognition method 200 according to an embodiment of the present disclosure. As shown in FIG. 2, the method 200 includes the following steps.

In step S202, a whole-image scenario and a text image of an image to be processed are obtained.

In step S204, a first text recognition model corresponding to the whole-image scenario is determined.

In step S206, text recognition is performed on the text image according to the first text recognition model to obtain text information.

According to the text recognition method of the embodiment of the present disclosure, the text recognition can be performed based on the text recognition model corresponding to the whole-image scenario of the image to be processed, and therefore, a scenario-based recognition element can be introduced in the process of text recognition, thereby solving the problem of low accuracy caused by using a single general-used text recognition model and accordingly improving the accuracy of text recognition in various application scenarios. Therefore, the text recognition method according to the embodiment of the present disclosure can be self-adapted to various scenarios and multi-word distribution, thereby ensuring that an effective text recognition solution is provided for wide application fields.

In the technical solution of the present disclosure, the involved acquisition, storage and application of the image comply with the provisions of relevant laws and regulations, and do not violate public order and good customs.

One or more aspects of various steps of the text recognition method according to the embodiment of the present disclosure will be described in detail below.

In step S202, the image to be processed may involve many scenarios in which text recognition is applied, which may depend on the application fields in which text recognition needs to be used. For example, the image to be processed may involve, for example, bills or certificates, where automatic text recognition can help to save time of information entry. For another example, the image to be processed may involve a screenshot or a picture from the network, where automatic text recognition can help to quickly obtain text information in the picture.

Therefore, the whole-image scenario of the image to be processed may refer to a scenario where text recognition is applied, such as the bill or certificate scenario, or the network screenshot or picture scenario. In other words, the whole-image scenario of the image to be processed can reflect which specific application field of text recognition the image to be processed is involved in, for example, whether to perform text recognition for certificates or to perform text recognition for network screenshots.

In an example, the whole-image scenario of the image to be processed may be directly obtained.

In another example, the whole-image scenario of the image to be processed may be obtained by performing scenario recognition on the image to be processed. Each scenario may have at least one scenario feature characterizing scenario properties of the scenario. For example, for a street view scenario, the scenario feature may be, for example, buildings, roads, and the like. For a document scenario, the scenario feature may be, for example, a large quantity of words, and the like. Similarly, other candidate scenarios may also have respective scenario features characterizing respective scenario properties of the scenarios. Therefore, the scenario to which the image to be processed belongs, that is, the whole-image scenario may be recognized based on the scenario feature.

For example, scenario recognition may be implemented by an neural network Inception known in the art, in which a feature enhancement module is designed following feature extraction to enhance spatial information of the features in a channel dimension, thereby establishing a relationship between different spatial information, and thus improving the accuracy of scenario recognition. In addition, input data of the neural network is the whole image to be processed, rather than text lines in the image to be processed. This is because taking the whole-image as a processing object can ensure that all visual information is utilized in maximum, which is beneficial to determine which scenario the image to be processed belongs to based on the scenario feature of each scenario.

Before step S204, according to some embodiments, the method 200 may further include the following steps: candidate scenarios are obtained; and second text recognition models are classified based the candidate scenarios to build a correspondence between classification information and each of the second text recognition models.

Accordingly, the step S204 of determining the first text recognition model corresponding to the whole-image scenario may include the following steps: the first text recognition model is determined from the second text recognition models according to the whole-image scenario and the correspondence.

In this way, by presetting certain candidate scenario categories for the application fields involved in text recognition, the accuracy of text recognition can be improved by introducing the recognition element of the scenario. This is because at this time it is no longer like a traditional method that only uses a single general-used text recognition model, but an additional recognition element is added to assist the subsequent text recognition.

In an example, considering the wide range of application fields involved in the practical application of text recognition, the candidate scenarios may include seven scenarios, for example, a street view scenario, a network picture scenario, a commodity scenario, a document scenario, a snapshot scenario, a card scenario, and a bill scenario.

The street view scenario may refer to an image content involving street views such as shops, street billboards, vehicles, pedestrians, and the like. The network picture scenario may involve web screenshots or pictures from instant messaging softwares, social media sites, or video playing sites, or the like. The commodity scenario may involve a commodity text picture containing a commodity or a commodity logo. The document scenario may involve pictures of documents such as files. The snapshot scenario may involve pictures taken in any natural scenario. The card scenario may refer to an image content involving certificates or cards such as bank cards and ID cards. The bill scenario may refer to an image content involving bills such as invoices, itineraries, and the like.

Generally speaking, the above seven candidate scenarios can almost cover all application fields in which text recognition is currently applied. However, those skilled in the art can also understand that the above-mentioned candidate scenarios are examples for illustrating the methods of the embodiments of the present disclosure. In practical applications, the candidate scenarios may be reduced or expanded according to actual conditions, which is not intended to be limited by the present disclosure.

Therefore, the respective text recognition model can be obtained through classification based on the candidate scenarios, that is, the correspondence between the classification information and each of the text recognition models can be obtained. For example, by taking the street view scenario as an example, the correspondence between classification information about the street view and a corresponding street view recognition model can be obtained. Similarly, for the above-mentioned seven candidate scenarios, the correspondence between classification information about each scenario and a corresponding recognition model can be obtained.

In addition, one of the candidate scenarios may be used as a base scenario. In an example, the base scenario may be, for example, the above-mentioned snapshot scenario. Since the snapshot scenario itself may involve pictures taken in any natural scenario, the corresponding scenario features are more general than the scenario features of other scenarios. In this case, the snapshot scenario may be used as the base scenario, which is to be used when scenario recognition is difficult or hard to perform.

In this way, in the case where the degree of discrimination between the scenarios is low or the obvious scenario features are absent, the base scenario may be used so that the preset candidate scenarios can cover all the application scenarios.

In step S204, according to some embodiments, determining the first text recognition model from the second text recognition models according to the whole-image scenario and the correspondence may include the following steps: a degree of confidence for the whole-image scenario is obtained; and in response to determining that the degree of confidence is lower than a threshold, one of the second text recognition models corresponding to the base scenario is determined as the first text recognition model.

As mentioned above, the whole-image scenario may be obtained, for example, by scenario recognition. At this time, it can be determined whether the recognized whole-image scenario is accurate or not, that is, the degree of confidence of the recognized whole-image scenario. Herein, setting the base scenario can play the following role: if the degree of confidence is low when determining the accuracy of the whole-image scenario through a mechanism of detecting the degree of confidence, that is, the accuracy is low, the base scenario that is more general can be used to cover the scenario at this time, which can avoid the inaccuracy of subsequent text recognition due to inaccurate classification.

In an example, when determining whether the whole-image scenario is accurate or not, for example, one or more scenario features of the image to be processed may be arbitrarily selected, and it may be determined whether the selected scenario features are consistent with the recognized scenario, thereby giving a corresponding score for the degree of confidence of scenario recognition. The threshold of the degree of confidence may be variously set depending on the requirements for classification accuracy.

Therefore, when the score for the degree of confidence is lower than the threshold, it can be determined that scenario recognition is inaccurate. Therefore, at this time, the text recognition model corresponding to the base scenario may be determined as the text recognition model that will perform the text recognition operation.

In addition, in the case that the base scenario is included, the text recognition model corresponding to the base scenario may be trained with training images including at least two candidate scenarios, and may be used as a pre-training model to train the text recognition models corresponding to the remaining scenarios in the plurality of candidate scenarios.

By taking the snapshot scenario as the base scenario as an example, training images including at least two candidate scenarios, such as the above-mentioned seven scenarios (i.e., the street view scenario, the network picture scenario, the commodity scenario, the document scenario, the snapshot scenario, the card scenario and the bill scenario) may be used to train the text recognition model corresponding to the base scenario. Assuming that each scenario has one million training images, a total of seven million training images may be fused together as training images for training the text recognition model corresponding to the base scenario.

Meanwhile, the trained text recognition model corresponding to the base scenario may be used as a pre-training model to train the text recognition models corresponding to the remaining six scenarios (i.e., the street view scenario, the network picture scenario, the commodity scenario, the document scenario, the card scenario and the bill scenario). Here, for each of the six scenarios, training images of the corresponding scenario may be further used for the training. That is, the text recognition model corresponding to the street view scenario may be trained by using the training images containing the street view scenario, and the remaining text recognition models may be trained in a similar manner, where the training is performed with the training images of the corresponding scenarios. In an example, the text recognition models corresponding to the seven scenarios may all use ResNet (a residual network) as a backbone.

In this way, since the text recognition model corresponding to the base scenario is trained through several rounds of iterations by a large amount of fused training data, it may have a certain generality so that in the case of wrong scenario recognition happened, switching to the text recognition model corresponding to the base scenario may instead achieve a higher accuracy, which is relative to the wrong scenario recognition. For example, if the commodity scenario is determined as a document scenario by mistake during scenario recognition, the accuracy achieved by recognition via the text recognition model corresponding to the document scenario may be lower than the accuracy achieved by recognition via the text recognition model corresponding to the base scenario.

In step S206, the text recognition operation may be implemented by using a convolutional recurrent neural network (CRNN) and connectionist temporal classification (CTC) decoding known in the art. In addition, the input data is a word-level or line-level image of the text, which does not need to be labeled with detailed character-level information.

As mentioned above, according to the text recognition method of the embodiment of the present disclosure, text recognition can be performed based on the text recognition model corresponding to the whole-image scenario of the image to be processed, and therefore, a scenario-based recognition element can be introduced in the process of text recognition, thereby solving the problem of low accuracy caused by using the single general-used text recognition model and accordingly improving the accuracy of text recognition in various application scenarios.

FIG. 3 shows a flow diagram of a text recognition method 300 according to another embodiment of the present disclosure.

As shown in FIG. 3, the method 300 may include an image obtaining step S302, a whole-image scenario obtaining step S304, a text image obtaining step S305, a scenario-and-text association step S306, and a scenario-based text recognition step S308.

According to the method 300, in the process of executing the whole-image scenario obtaining step S304, the text image obtaining step S305 may be executed concurrently, that is, the text image obtaining step S305 and the whole-image scenario obtaining step S304 may be executed concurrently.

In this way, the text image obtaining operation and the whole-image scenario obtaining operation may be performed independently of each other, so that obtaining of a text image is not required by a specific scenario, and accordingly the method of the embodiments of the present disclosure can be oriented to various word distributions. At the same time, since the text image obtaining operation and the whole-image scenario obtaining operation are performed concurrently, the processing time can also be saved, and the overall text recognition speed can be improved.

In an example, the text image obtaining step S305 may include performing a crop operation on text lines of the text image to extract at least one text line. In step S306, each text line in the at least one text line may be associated with the scenario acquired in the whole-image scenario obtaining step S304.

For example, if ten text lines are detected and extracted, each text line may be assigned a scenario property, that is, each of all the ten text lines may have the same scenario property. Therefore, based on the scenario property, each text line may be recognized by a text recognition model corresponding to the scenario in the subsequent scenario-based text recognition step S308. In an example, a patch may be constructed for each text line, which may include the text line and the scenario property thereof. In step S308, each patch may be distributed to the text recognition model corresponding to the scenario, thereby obtaining an end-to-end text recognition result.

In this way, a patch for each text line is independently constructed for end-to-end text recognition, so that the respective text line can be recognized according to its scenario by using the corresponding text recognition model, thereby improving the accuracy of text recognition.

According to some embodiments, the scenario-based text recognition step S308 may include determining a text length of each text line; and distributing, based on the text length, each text line to a text recognition sub-model included in the first text recognition model corresponding to each text line to perform text recognition for obtaining text information, where at least two text lines distributed to the same text recognition sub-model are simultaneously input to the text recognition sub-model.

For example, if ten text lines are detected and extracted, then the ten text lines may be sorted according to their text lengths and allocated to different length intervals. In the example, three length thresholds may be set, e.g., 256, 512, 1024 (which may refer to the number of pixels), and the ten text lines may be respectively allocated to corresponding ones of four intervals including [0, 256], [256, 512], [512, 1024], and [1024, . . . ]. In other words, in this case, the text recognition model may include four text recognition sub-models, which are respectively configured to process the text lines corresponding to the above-mentioned length intervals.

In this way, the problem of traditional method caused by serial processing in text recognition can be solved, so that text lines that have large differences in length can be processed through the respective sub-models concurrently, while text lines that have small differences in length can be processed through the same sub-model concurrently in the same batch, thereby increasing the text recognition speed.

Therefore, the text recognition method according to the embodiment of the present disclosure can be self-adapted to various scenarios and multi-word distribution, thereby ensuring that an effective text recognition solution is provided for wide application fields.

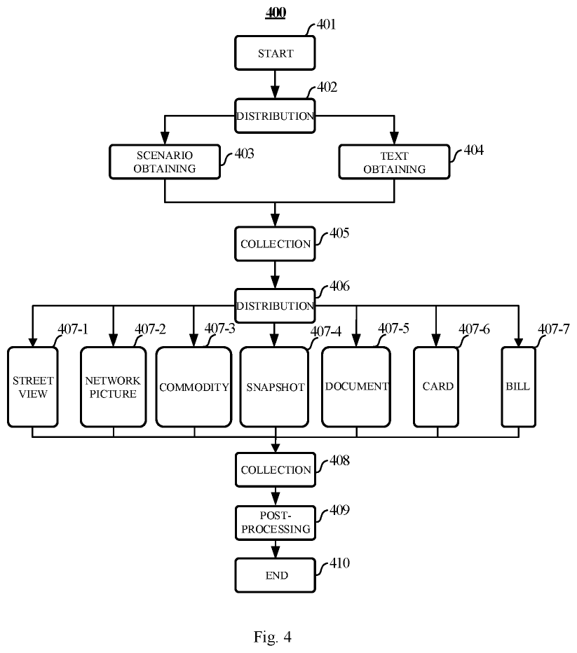

FIG. 4 shows a schematic diagram of an automated recognition service pipeline for illustrating a text recognition method according to an embodiment of the present disclosure.

As shown in FIG. 4, the automated recognition service pipeline may start at a process 401, where an image to be processed may be obtained. For example, the image to be processed obtained at the process 401 may be, for example, a photograph or an electronically scanned picture of an ID card. It can be understood that, according to various fields where text recognition is applied, the image to be processed may also involve different scenarios. Therefore, the image to be processed includes not only a text to be recognized, but also scenario information of the scenario related to an image content.

The process 401 may continue to a distribution process 402, where the obtained image to be processed may be distributed to a scenario obtaining process 403 and a text obtaining process 404, respectively. The scenario obtaining process 403 and the text obtaining process 404 may be executed concurrently.

In the scenario obtaining process 403, scenarios may include seven scenarios, namely, a street view scenario, a network picture scenario, a commodity scenario, a document scenario, a snapshot scenario, a card scenario, and a bill scenario. In other words, in the scenario obtaining process 403, classification information of a whole-image scenario of the image to be processed may be obtained. In addition, the snapshot scenario may also be set as a base scenario.

In the text obtaining process 404, at least one text line may be detected and extracted.

The respective processing results of the scenario obtaining process 403 and the text obtaining process 404 may be collected at a collection process 405. Here, each text line may be made associated with the recognized scenario. In order to do this, a patch may be constructed for each text line, which may include the respective text line and the scenario thereof. In addition, the accuracy of scenario recognition may be additionally determined here to determine whether the scenario needs to be modified to the base scenario. That is, in the case of inaccurate scenario recognition, the text line may be made associated with the base scenario instead of the recognized scenario.

The collection process 405 may continue to a distribution process 406 to distribute the patch constructed for each text line to one of text recognition models 407-1 to 407-7 corresponding to the scenario. For example, in the case where the scenario obtaining process 403 recognizes that the image to be processed involves the card scenario and the scenario recognition is accurate, then the distribution process 406 may accordingly distribute each patch of the text line to the text recognition model 407-6 corresponding to the card scenario.

The result of text recognition in any of text recognition models 407-1 to 407-7 may be collected in a collection process 408 to proceed to a subsequent post-processing process 409 and to a result process 410.

The automated recognition service of the text recognition method according to the embodiment of the present disclosure can self-adaptively perform scenario recognition for various scenarios and word distributions, and self-adaptively use the corresponding text recognition model to perform text recognition, thereby improving the accuracy of text recognition.

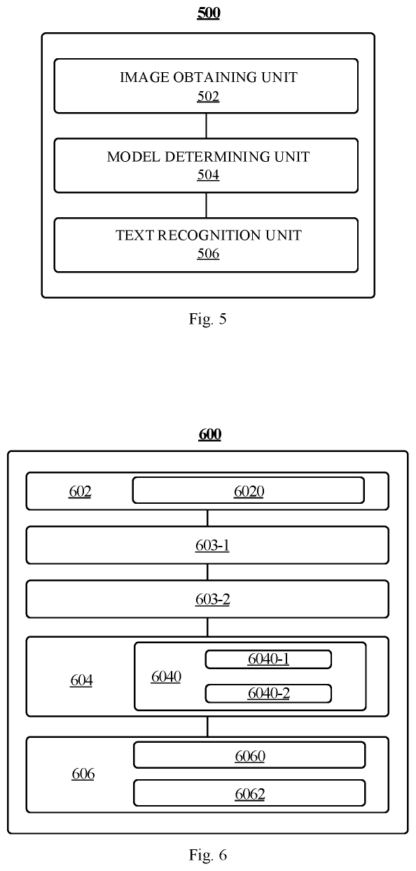

FIG. 5 shows a structural block diagram of a text recognition apparatus 500 according to an embodiment of the present disclosure.

As shown in FIG. 5, the apparatus 500 includes an image obtaining unit 502, a model determining unit 504 and a text recognition unit 506.

The image obtaining unit 502 is configured to obtain a whole-image scenario and a text image of an image to be processed.

The model determining unit 504 is configured to determine a first text recognition model corresponding to the whole-image scenario.

The text recognition unit 506 is configured to perform text recognition on the text image according to the first text recognition model to obtain text information.

The operations performed by the above-mentioned units 502 to 506 may correspond to steps S202 to S206 as described in conjunction with FIG. 2, so the details of each aspect thereof are omitted here.

FIG. 6 shows a block diagram of a text recognition apparatus 600 according to another embodiment of the present disclosure. Units 602, 604 and 606 as shown in FIG. 6 may correspond to the units 502, 504 and 506 as shown in FIG. 5, respectively.

According to some embodiments, the text recognition apparatus 600 may further include: a scenario obtaining unit 603-1 configured to obtain candidate scenarios; and a classifying unit 603-2 configured to classify second text recognition models based on the candidate scenarios to build a correspondence between classification information and each of the second text recognition models. One of the candidate scenarios is configured as a base scenario. The model determining unit 604 may include: a first determining subunit 6040 configured to determine the first text recognition model from the second text recognition models according to the whole-image scenario and the correspondence.

According to some embodiments, the first determining subunit 6040 may include: a degree-of-confidence obtaining unit 6040-1 configured to obtain a degree of confidence for the whole-image scenario; and a base scenario determining unit 6040-2 configured to determine, in response to determining that the degree of confidence is lower than a threshold, the second text recognition model corresponding to the base scenario as the first text recognition model. The second text recognition model corresponding to the base scenario may be obtained by training according to training images including at least two candidate scenarios.

According to some embodiments, the text recognition unit 606 may include: a length determining unit 6060 configured to determine a text length of a text line, the text image including the text line; and a distributing unit 6062 configured to distribute, based on the text length, the text line to a text recognition sub-model included in the first text recognition model, to perform text recognition for obtaining the text information, where at least two text lines distributed to the same text recognition sub-model are input to the text recognition sub-model simultaneously.

According to some embodiments, the image obtaining unit 602 may include: a concurrent operation unit 6020 configured to obtain the whole-image scenario and the text image concurrently.

According to another aspect of the present disclosure, an electronic device is further provided, including: at least one processor; and a memory in communication connection with the at least one processor; where the memory stores instructions capable of being executed by the at least one processor, and the instructions are executed by the at least one processor to cause the at least one processor to be capable of executing the method according to the embodiment of the present disclosure.

According to another aspect of the present disclosure, a non-transitory computer readable storage medium storing computer instructions is provided. The computer instructions are configured to cause a computer to execute the method according to the embodiment of the present disclosure.

According to another aspect of the present disclosure, a computer program product is provided, including a computer program. The computer program, when executed by a processor, implements the method according to the embodiment of the present disclosure.

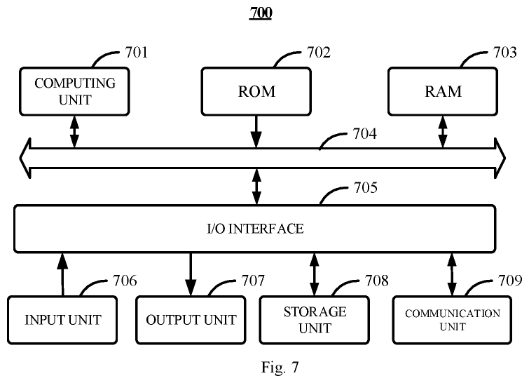

Referring to FIG. 7, a structural block diagram of an electronic device 700 that may serve as a server or a client of the present disclosure will now be described, and it is an example of a hardware device that may be applied to various aspects of the present disclosure. The electronic device is intended to represent various forms of digital electronic computer devices, such as, a laptop computer, a desktop computer, a workstation, a personal digital assistant, a server, a blade server, a mainframe computer, and other suitable computers. The electronic device may further represent various forms of mobile apparatuses, such as, personal digital processing, a cell phone, a smart phone, a wearable device and other similar computing apparatuses. The components shown herein, their connections and relationships, and their functions are merely used as examples, and are not intended to limit the implementations of the present disclosure described and/or required herein.

As shown in FIG. 7, the electronic device 700 includes a computing unit 701 that may perform various appropriate actions and processing according to computer programs stored in a read-only memory (ROM) 702 or computer programs loaded from a storage unit 708 into a random access memory (RAM) 703. In the RAM 703, various programs and data required for operations of the electronic device 700 may further be stored. The computing unit 701, the ROM 702 and the RAM 703 are connected to each other through a bus 704. An input/output (I/O) interface 705 is also connected to the bus 704.

A plurality of components in the electronic device 700 are connected to the I/O interface 705, including: an input unit 706, an output unit 707, a storage unit 708 and a communication unit 709. The input unit 706 may be any type of device capable of inputting information to the electronic device 700. The input unit 706 may receive input digital or character information and generate key signal input related to user settings and/or function control of the electronic device, and may include but not limited to a mouse, a keyboard, a touch screen, a trackpad, a trackball, a joystick, a microphone and/or a remote control. The output unit 707 may be any type of device capable of presenting information, and may include but not limited to a display, a speaker, a video/audio output terminal, a vibrator and/or a printer. The storage unit 708 may include but not limited to a magnetic disk and an optical disk. The communication unit 709 allows the electronic device 700 to exchange information/data with other devices through computer networks such as the Internet and/or various telecommunication networks, and may include but not limited to a modem, a network card, an infrared communication device, a wireless communication transceiver and/or a chipset, such as a Bluetooth® device, a 802.11 device, a WiFi device, a Worldwide Interoperability for Microwave Access (WiMax) device, a cellular communication device and/or the like.

The computing unit 701 may be various general-purpose and/or special-purpose processing components with processing and computing capabilities. Some examples of the computing unit 701 include but not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, etc. The computing unit 701 performs various methods and processing described above, such as the text recognition method. For example, in some embodiments, the text recognition method may be implemented as a computer software program that is tangibly included in a machine-readable medium such as the storage unit 708. In some embodiments, part or all of the computer programs may be loaded and/or installed onto the electronic device 700 via the ROM 702 and/or the communication unit 709. When the computer programs are loaded into the RAM 703 and executed by the computing unit 701, one or more steps of the text recognition method described above may be performed. Alternatively, in other embodiments, the computing unit 701 may be configured to perform the text recognition method in any other suitable manner (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally far away from each other and usually interact through a communication network. The relationship between the client and the server is generated by computer programs running on the corresponding computer and having a client-server relationship with each other. The server may be a cloud server, and may also be a server of a distributed system, or a server combined with a block chain.

It should be understood that the various forms of processes shown above may be used to reorder, add, or delete steps. For example, the steps recorded in the present disclosure may be performed concurrently, sequentially or in different orders, as long as the desired results of the technical solution disclosed by the present disclosure can be achieved, which is not limited herein.

In the technical solution of the present disclosure, the involved acquisition, storage and application of the image comply with the provisions of relevant laws and regulations, and do not violate public order and good customs.

Although the embodiments or examples of the present disclosure have been described with reference to the accompanying drawings, it should be understood that the above methods, systems and devices are only example embodiments or examples, and the scope of the present disclosure is not limited by these embodiments or examples, but only by the authorized claims and their equivalent scope. Various elements in the embodiments or examples may be omitted or replaced by their equivalent elements. In addition, the steps may be performed in an order different from that described in the present disclosure. Further, various elements in the embodiments or examples may be combined in various ways. It is important that as technology evolves, many of the elements described herein may be replaced by equivalent elements that appear after the present disclosure.

What is claimed is:

1. A method for text recognition, comprising:
obtaining a whole-image scenario for an image to be processed and a text image in the image to be processed;
determining a first text recognition model corresponding to the whole-image scenario; and
performing text recognition on the text image based on the first text recognition model to obtain text information.

2. The method according to claim 1, further comprising:
obtaining candidate scenarios; and
classifying, based on the candidate scenarios, second text recognition models to build a correspondence between classification information and each of the second text recognition models;
wherein one candidate scenario of the candidate scenarios is configured as a base scenario, and
wherein determining the first text recognition model corresponding to the whole-image scenario comprises:
determining the first text recognition model from the second text recognition models based on the whole-image scenario and the correspondence between the classification information and each of the second text recognition models.

3. The method according to claim 2, wherein determining the first text recognition model from the second text recognition models comprises:
obtaining a degree of confidence for the whole-image scenario; and
in response to determining that the degree of confidence is lower than a threshold, determining one of the second text recognition models corresponding to the base scenario as the first text recognition model;
wherein the one candidate scenario of the second text recognition models corresponding to the base scenario is obtained by training according to training images comprising at least two candidate scenarios.

4. The method according to claim 1, wherein performing text recognition on the text image based on the first text recognition model to obtain the text information comprises:
determining a text length of a text line, wherein the text line is included in the text image; and
distributing, based on the text length, the text line to a text recognition sub-model included in the first text recognition model corresponding to the text line to perform text recognition for obtaining the text information, wherein at least two text lines distributed to the same text recognition sub-model are input to the text recognition sub-model simultaneously.

5. The method according to claim 1, wherein obtaining the whole-image scenario for the image to be processed and the text image in the image to be processed comprises:
obtaining the whole-image scenario and the text image concurrently.

6. An electronic device, comprising:
at least one processor; and
a memory in communication connection with the at least one processor,
wherein the memory stores instructions executable by the at least one processor, and the instructions, when executed by the at least one processor, enable the at least one processor to execute processing comprising:
obtaining a whole-image scenario for an image to be processed and a text image in the image to be processed;
determining a first text recognition model corresponding to the whole-image scenario; and
performing text recognition on the text image based on the first text recognition model to obtain text information.

7. The electronic device according to claim 6, wherein the processing further comprises:
obtaining candidate scenarios; and
classifying, based on the candidate scenarios, second text recognition models to build a correspondence between classification information and each of the second text recognition models;
wherein one candidate scenario of the candidate scenarios is configured as a base scenario, and
wherein determining the first text recognition model corresponding to the whole-image scenario comprises:
determining the first text recognition model from the second text recognition models based on the whole-image scenario and the correspondence between the classification information and each of the second text recognition models.

8. The electronic device according to claim 7, wherein determining the first text recognition model from the second text recognition models comprises:
obtaining a degree of confidence for the whole-image scenario; and
in response to determining that the degree of confidence is lower than a threshold, determining one of the second text recognition models corresponding to the base scenario as the first text recognition model;
wherein the one candidate scenario of the second text recognition models corresponding to the base scenario is obtained by training according to training images comprising at least two candidate scenarios.

9. The electronic device according to claim 6, wherein performing text recognition on the text image based on the first text recognition model to obtain the text information comprises:
determining a text length of a text line, wherein the text line is included in the text image; and
distributing, based on the text length, the text line to a text recognition sub-model included in the first text recognition model corresponding to the text line to perform text recognition for obtaining the text information, wherein at least two text lines distributed to the same text recognition sub-model are input to the text recognition sub-model simultaneously.

10. The electronic device according to claim 6, wherein obtaining the whole-image scenario for the image to be processed and the text image in the image to be processed comprises:
obtaining the whole-image scenario and the text image concurrently.

11. A non-transitory computer readable storage medium storing computer instructions that, when executed by a computer, are configured to cause the computer to execute processing comprising:
obtaining a whole-image scenario for an image to be processed and a text image in the image to be processed;
determining a first text recognition model corresponding to the whole-image scenario; and
performing text recognition on the text image based on the first text recognition model to obtain text information.

12. The non-transitory computer readable storage medium according to claim 11, wherein the processing further comprises:
obtaining candidate scenarios; and
classifying, based on the candidate scenarios, second text recognition models to build a correspondence between classification information and each of the second text recognition models;
wherein one candidate scenario of the candidate scenarios is configured as a base scenario, and
wherein determining the first text recognition model corresponding to the whole-image scenario comprises:
determining the first text recognition model from the second text recognition models based on the whole-image scenario and the correspondence between the classification information and each of the second text recognition models.

13. The non-transitory computer readable storage medium according to claim 12, wherein determining the first text recognition model from the second text recognition models comprises:
obtaining a degree of confidence for the whole-image scenario; and
in response to determining that the degree of confidence is lower than a threshold, determining one of the second text recognition models corresponding to the base scenario as the first text recognition model;
wherein the one candidate scenario of the second text recognition models corresponding to the base scenario is obtained by training according to training images comprising at least two candidate scenarios.

14. The non-transitory computer readable storage medium according to claim 11, wherein performing text recognition on the text image based on the first text recognition model to obtain the text information comprises:
determining a text length of a text line, wherein the text line is included in the text image; and
distributing, based on the text length, the text line to a text recognition sub-model included in the first text recognition model corresponding to the text line to perform text recognition for obtaining the text information, wherein at least two text lines distributed to the same text recognition sub-model are input to the text recognition sub-model simultaneously.

15. The non-transitory computer readable storage medium according to claim 11, wherein obtaining the whole-image scenario for the image to be processed and the text image in the image to be processed comprises:
obtaining the whole-image scenario and the text image concurrently.
